(19) United States
(12) Patent Application Publication
(10) Pub. No.: US 2011/0213837 A1
(43) Pub. Date: Sep. 1, 2011

(54) System and Method for Evaluating and Analyzing Content

(76) Inventor: Jason Beebe, Gilbert, AZ (US)

(21) Appl. No.: 12/713,415

(22) Filed: Feb. 26, 2010

(51) Int. Cl. G06F 15/16; G06F 3/048

(52) U.S. Cl. 709/204; 715/771; 709/231

(57) ABSTRACT

A system for evaluating content includes a plurality of client computer systems, each one of the client computer systems configured to perform the steps of playing content on a media player; capturing, while the content is playing, a plurality of ratings from a user, each one of the ratings corresponding to a different play time; and sending the plurality of ratings and the corresponding play times to a media analyzer. The system further includes the media analyzer configured to perform the steps of, from a plurality of users, receiving a plurality of ratings and corresponding play times; grouping the ratings and corresponding play times according to content being rated; and analyzing the grouped ratings. Preferably, the media analyzer can store ratings from different content being played and evaluated simultaneously.

### FIELD OF THE INVENTION

The present invention relates to a system and method for evaluating and analyzing content.

### BACKGROUND

An ongoing problem for content developers has been to assess the value of their work to an audience.

For television, a common way to measure audience interest is to install a device (commonly referred to as a “People Meter”) on television sets of sample households to determine the shows that they watch. Based on the results of the sample, it is possible to determine with a certain degree of confidence the approximate audience size for various shows. Although useful for certain purposes, this approach has many limitations. In particular, the device does not provide information as to which parts of a show were liked or not, and it is limited to evaluating television audiences.

Various other methods of evaluating audience interest have been developed. An early attempt is disclosed in U.S. Pat. No. 3,328,803 to Papadopoulos et al. In this patent, selected members of an audience are assembled in a room and supplied with hard-wired devices for measuring their response to a presentation. Unfortunately, this approach is difficult to perform on a large scale.

To obtain more robust information, some content developers have used focus groups to assess an audience's reaction. In general, a focus group includes an audience situated in a room with a moderator who asks questions. To evaluate content, such as the content of an advertisement, the audience typically views the content and then is asked questions. The moderator can work on a scripted basis or an unscripted basis. In either case, focus groups tend to be small and provide only limited information due to their size and difficulty in assembling a representative mix of participants.

### SUMMARY OF THE INVENTION

A system for evaluating content includes a plurality of client computer systems, each one of the client computer systems configured to perform the steps of playing content on a media player; capturing, while the content is playing, a plurality of ratings from a user, each one of the ratings corresponding to a different play time; and sending the plurality of ratings and the corresponding play times to a media analyzer. The system further includes the media analyzer configured to perform the steps of, from a plurality of users, receiving a plurality of ratings and corresponding play times; grouping the ratings and corresponding play times according to content being rated; and analyzing the grouped ratings. Preferably, the media analyzer can store ratings from different content being played and evaluated simultaneously.

Preferably, the ratings are entered by the user using one of a vertical slider, a mouse, a keyboard, a touch screen, and a joystick. Preferably, the screen display area also includes an area for graphically showing the ratings entered by the user.

Preferably, demographic information is collected from the user and a unique session identifier is assigned to identify the evaluation. Preferably, a unique media identifier is used to identify the content. Preferably, he content is one of video, audio, and text. Preferably, the content is streamed to the user in real time or near real time.

Preferably, the system can be configured to prompt the user for at least one question which is asked to the user at a predetermined play time.

These and other aspects, features and advantages of the present invention will become apparent from the following detailed description of preferred embodiments, which is to be read in connection with the accompanying drawings.

### BRIEF DESCRIPTION OF THE DRAWINGS

FIG. 1 shows an exemplary content evaluation system, according to a preferred embodiment of the present system;

FIG. 2 shows an exemplary content evaluation tool useable by a person evaluating content;

FIG. 3 shows a flow chart of an exemplary method for evaluating content, according to a preferred embodiment of the present invention;

FIG. 4(a) shows an exemplary table for storing rating information;

FIG. 4(b) shows an exemplary table for storing user questions; and

FIG. 5 shows a media analysis tool used by a content developer to analyze user evaluations.

### DETAILED DESCRIPTION

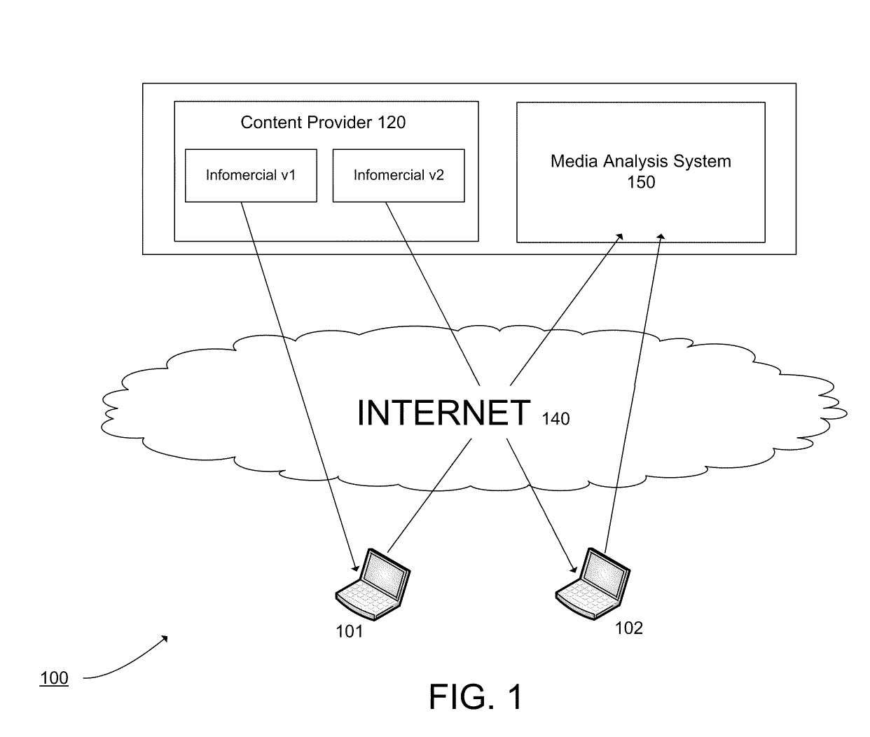

FIG. 1 shows a content evaluation system 100. The content evaluation system 100 includes a content provider 120, a media analysis system 150, and a plurality of client computer systems 101, 102. As depicted in FIG. 1, the client computer systems 101, 102 are connected via the Internet 140 to both the content provider 120 and the media analysis system 150. As will be described in greater detail, each of the client computer systems 101, 102 uses a content evaluation tool for rating content provided by the content provider 120. According to a preferred embodiment of the present invention, the computer systems 101, 102 each have installed the Adobe Flash Player by Adobe Systems Inc., of San Jose, Calif. However, it is to be appreciated that the present invention is not limited to implementation with Adobe Flash technology.

For illustrative purposes, as shown in FIG. 1, the client computer systems 101, 102 are provided with separate versions of an “infomercial” by the content provider 120. In this example, the client computer system 101 is provided with a first version of the infomercial and the client computer system 102 is provided with a second version of the infomercial. As the users utilize the content evaluation tool to rate the respective content, the ratings and corresponding play times are sent to the media analysis system 150 for analysis. Such analysis might include, for example, a comparison of ratings of a portion of the infomercial as originally broadcast with a portion of the infomercial with changes made. The results of this analysis, if properly conduced and having a sufficient sample size, could help the content developer decide whether to make the changes. While FIG. 1 depicts only two client computer systems 101, 102, it is to be appreciated that the content analysis system 100 would usually include many more client computer systems, so that the results would reflect a more meaningful sample.

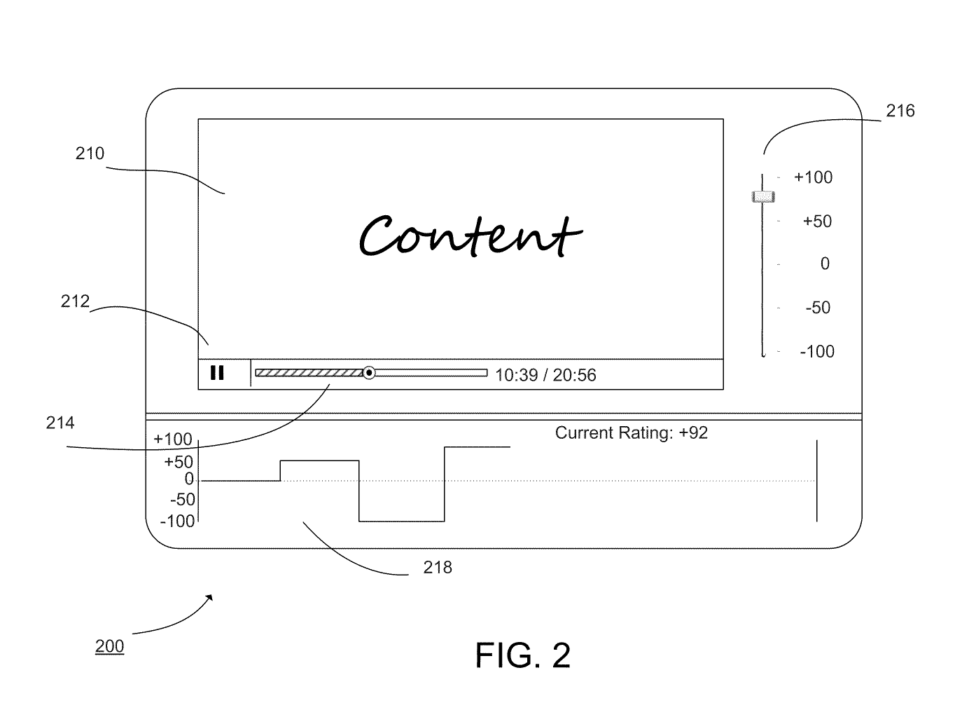

FIG. 2 illustrates an exemplary content evaluation tool 200 useable to collect content evaluations, according to a preferred embodiment of the present invention. As shown, the content evaluation tool 200 includes a media player 210 having a pause button 212 and a progress bar 214. The media player 210 can include the Adobe Flash Player or similar streaming media player. As the media player plays content provided by the content provider 120, the progress bar 214 moves to indicate the elapsed play time. As shown, next to the progress bar 214 is the play time and the total media length.

Additionally, the content evaluation tool 200 includes a vertical slider 216 for entering a user rating and a rating graph 218 for visually illustrating the entered ratings for the provided content. Preferably, the vertical slider 216 is originally set to a neutral position (e.g., 0) when the player starts and reverts to this neutral position if no rating has been entered for a predetermined length of time (e.g., 20 seconds). As shown, the vertical slider 216 allows for entry of ratings from −100 to +100. However, it is to be appreciated that another rating scale could be employed, such as, for example a rating scale from 0 to 10. Furthermore, it is to be understood that the although in this example a vertical slider 216 is used for data entry, other suitable widgets may instead be used, for example, a horizontal slider, radio buttons, a text entry box, etc.

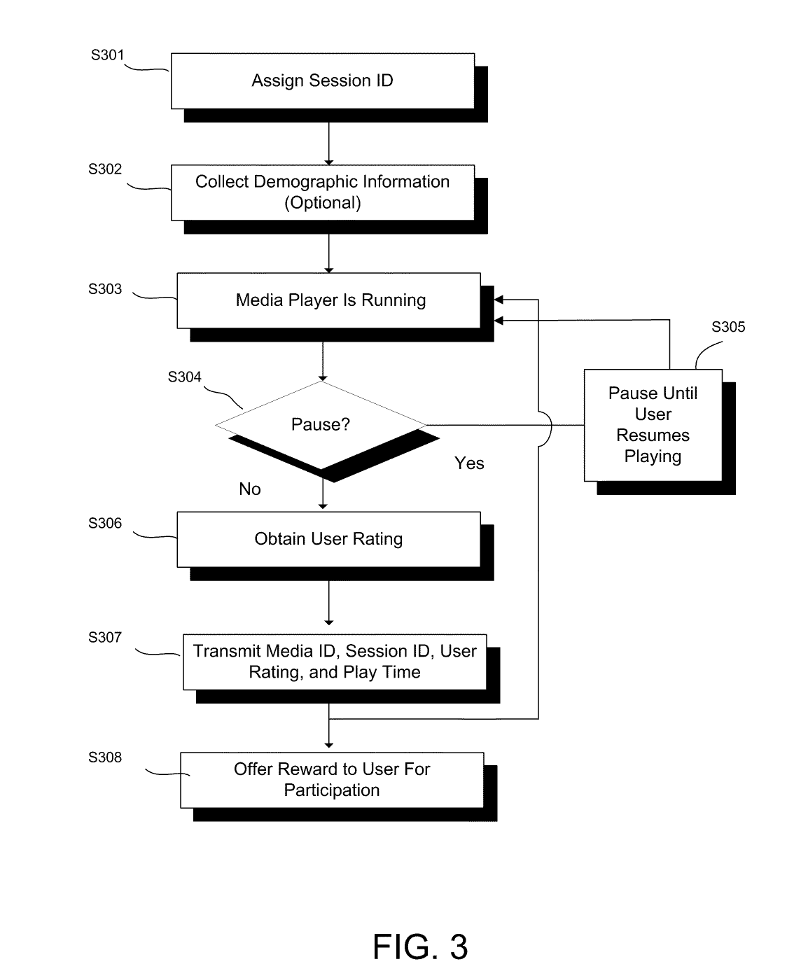

FIG. 3 shows a flow chart of a method for evaluating content, according to a preferred embodiment of the present invention. This method depicts the flow of control for a particular client computer system 101, 102.

Initially, in step S301, a unique session identifier is assigned.

In step S302, demographic information is, optionally, collected from the user. For example, the user may be prompted for such information as age, gender, ethnic group, income level, etc.

In step S303, the user starts the media player 210 (or, alternatively, the media player 210 automatically starts). At any time, the user can, in step S304, click the pause button 212, to pause the media player. If the pause button 212 is clicked, then control passes to step S305 where the media player 210 pauses until the user resumes playing by again clicking the pause button 212.

While the media player 210 is playing, the user can rate the content at any time by moving the vertical slider 216 to the desired rating. For example, the user might have not have enjoyed the introduction and rated it as a “−50” but liked the testimonials and rated them “+92”. Preferably, whenever the user fails to enter a rating for more than a predetermined length, e.g., 20 seconds, the vertical slider 216 moves to the “0” (neutral) position. The user ratings are displayed graphically in the rating graph 218, as shown.

Each time the user moves the vertical slider 216 to the desired rating, in step S306, the user rating and corresponding play time is obtained. For example, if after 32 seconds, the user enters “+90” using the vertical slider, the rating of “+90” and the corresponding play time “32 seconds” would be obtained.

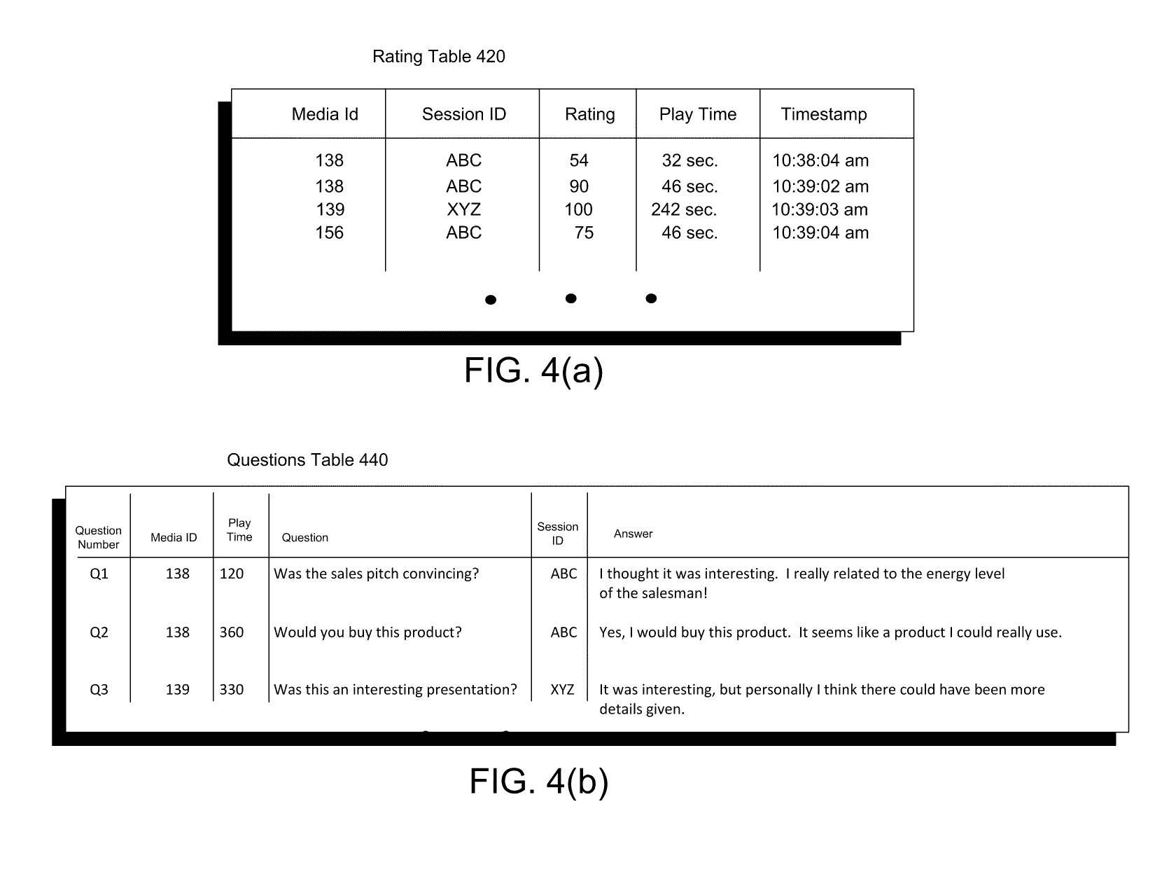

In step S307, a media identifier that identifies the particular content, the session identifier, the user rating, and the play time are transmitted from the client computer system 101, 102 to the media analysis system 150. FIG. 4(a) shows an exemplary rating table 420 situated at the media analysis system 150 for storing this information.

In step S308, a reward can be provided to the user for participating in the evaluation. As an example, the reward could include a coupon.

An optional step in the above (not shown) involves providing specific questions to the user to be posed at predetermined play times. FIG. 4(b) shows an exemplary questions table 440 suitable for storing questions. In this table, for example, the question “Was the sales pitch convincing?” would be posed to the user playing content having media ID 138 at a play time of 120 seconds. In this example, a user with a session identifier “ABC” responded (in freeform text) “I thought it was interesting. I really related to the energy level of the salesman!” Such questions can be very useful in gleaning the reasons a user reacted as he or she did.

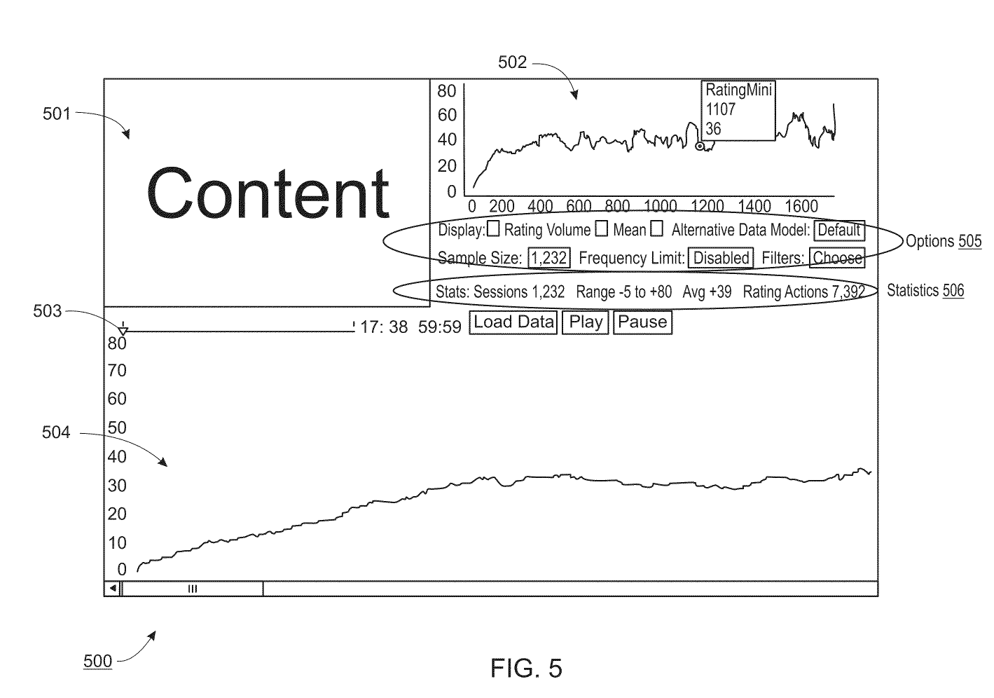

FIG. 5 shows an exemplary media analysis tool 500 used by a content developer to analyze user evaluations. As illustrated, the media analysis tool 500 includes a media player 501, a small graph 502, a media control bar 503, a high resolution graph 504, options 505, and statistics 506. The data presented on this screen can include an aggregate of all ratings collected from participants for a particular piece of content.

The media player 501 includes a media player for playing back selected content that was evaluated.

The small graph 502 shows ratings for an entire piece of content from start to finish. As depicted, the numerical value on the Y-axis represents the rating and the numerical value on the X-axis represents the play time (in seconds). As the media plays back, a marker follows along the graph. Hovering over the marker causes the actual play back point play time and rating to be displayed. In this example, the play time is 1107 seconds and the average rating is 36.

The media control bar 503 allows a user to skip to certain parts in the media. It also provides the current play time and the length of time of the media.

The high resolution graph 504 shows the ratings on a much larger scale so more detail can be seen for each data point. The user can use the scroll at the bottom to browse the graph. While the media is playing a marker (as in the small graph 502) will move so that one can see what part of the graph correspond to the media that is playing at that point in time. The high resolution graph 504 also has the hover box feature described above with respect to the small graph 502 to show a play time and rating at the chosen point.

An important aspect of the present invention is that various options of the media analysis tool 500 are configurable.

Options 505

Display Options: This allows a user to display additional lines graphed on both the small graph 502 and the high resolution graph 504.

Rating Volume: Shows the number of rating actions as a line chart so the operator can see how large the sample is for each point in time. This is important since not all users will rate the entire length of the media.

Alternative Data Models: Allows the operator to select other data models to calculate the results in alternative ways that might provide more ideal results.

Model Options:
Sample Size: Shows number of persons evaluating the content.
The sample size can adjusted by the user.
Filters: Allows user to select demographic filters.

Additionally, the user is presented with various useful statistics to further the analysis.

Statistics 506

Sessions: This is the number of different rating sessions that took place (which is, generally, the number of different people who rated it, though it is possible a person could go through the process more than once creating more than one session).

Range: This is the lowest average for any given point in the media to the highest average for any point in the media.

Average: This is the average rating given (i.e., the sum of all the ratings divided by the number of ratings).

Rating Actions: This is the number of different ratings recorded (a rating is recorded every time a user selected a different point on the scale during the process).

While this invention has been described in conjunction with the various exemplary embodiments outlined above, it is evident that many alternatives, modifications and variations will be apparent to those skilled in the art. Accordingly, the exemplary embodiments of the invention, as set forth above, are intended to be illustrative, not limiting. Various changes may be made without departing from the spirit and scope of the invention.

What is claimed is:

1. A method of evaluating content, comprising:
playing the content on a media player;
capturing, while the content is playing, a plurality of ratings from a user, each one of the ratings corresponding to a different play time; and
sending the plurality of ratings and the corresponding play times to a content analyzer.

2. The method of claim 1, wherein the ratings are based on a numerical scale.

3. The method of claim 1, wherein the ratings are entered by the user using one of a vertical slider, a mouse, a keyboard, a touch screen, and a joystick.

4. The method of claim 1, further including the step of graphically displaying the plurality of ratings to the user.

5. The method of claim 1, further including the step of collecting demographic information from the user.

6. The method of claim 1, further including the step of assigning a unique session identifier to identify the evaluation.

7. The method of claim 1, further including the step of assigning a unique media identifier to identify the content.

8. The method of claim 1, wherein the content is one of video, audio, and text.

9. The method of claim 1, further including the steps of prompting the user for at least one question and recording the user's answer to the question.

10. The method of claim 8, wherein the prompting occurs at a predetermined play time.

11. The method of claim 1, wherein the content is streamed from a network server.

12. The method of claim 1, wherein the method of evaluating content is performed on a client computer.

13. The method of claim 12, where the client computer is one of a laptop, a desktop, a tablet computer, and a smart phone.

14. The method of claim 1, wherein the method of evaluating content is performed at a kiosk.

15. A method of analyzing content, comprising:
from a plurality of users, receiving a plurality of ratings and corresponding play times;
grouping the ratings and corresponding play times according to content being rated; and
analyzing the grouped ratings and corresponding play times.

16. The method of analyzing content of claim 15, wherein the analyzing step includes graphically displaying the grouped ratings and corresponding play times.

17. The method of analyzing content of claim 15, wherein the analyzing step includes comparing the grouped ratings and corresponding play times for different content.

18. The method of analyzing content of claim 17, wherein the different content are versions of similar content.

19. The method of analyzing content of claim 17, wherein the analyzing includes one or more of:
for a selected play time,
graphically displaying a rating volume;
displaying a sample size;
displaying a number of sessions;
displaying a range;
displaying a rating average; and
displaying a number of rating actions.

20. A system for evaluating content, including:
a plurality of client computer systems, each one of the computer systems configured to perform the steps of
playing content on a media player;
capturing, while the content is playing, a plurality of ratings from a user, each one of the ratings corresponding to a different play time; and
sending the plurality of ratings and the corresponding play times to a content analyzer;
and
a server configured to perform the steps of
from a plurality of users, receiving the plurality of ratings and corresponding play times;
grouping the ratings and corresponding play times according to content being rated; and
analyzing the grouped ratings and corresponding play times;
wherein the plurality of ratings and corresponding play times received by the server include ratings and corresponding play times associated with several different content.
